(19) United States
(12) Patent Application Publication
(10) Pub. No.: US 2004/0234658 A1
(43) Pub. Date: Nov. 25, 2004

(54) Process for the controlled reduction of the sugar content of fruit juice and device for practicing this process

(76) Inventors: Jean Bonnet, Angers (FR); Herve De Vilmorin, Bordeaux (FR)

Correspondence Address: YOUNG & THOMPSON, 745 SOUTH 23RD STREET, 2ND FLOOR, ARLINGTON, VA, 22202, US

(21) Appl. No.: 10/801,011

(22) Filed: Mar. 16, 2004

(30) Foreign Application Priority Data
Mar. 19, 2003 (FR) 03 03372

(51) Int. Cl. A23P 1/00

(52) U.S. Cl. 426/489

(57) ABSTRACT

The present invention has for its object a process for the controlled reduction of the sugar content of fruit juice, in particular grape juice, characterized in that it consists in subjecting a portion (PJO) at least of the original fruit juice, if desired pre-clarified, to a selective ultra-filtration substantially permeable to sugars, then to a selective nano-filtration substantially impermeable to sugars, and in mixing the twice-filtered residue (PNF) with the rest of the permeate or concentrate of ultra-filtration (RUF) and, if desired, with the portion of the untreated original fruit juice (PJON), the ultra-filtration permeate (PUF) being subjected to treatment to eliminate or limit the phenomena of crystallization or formation of troublesome substances in the retentate or nano-filtration concentrate (RNF).

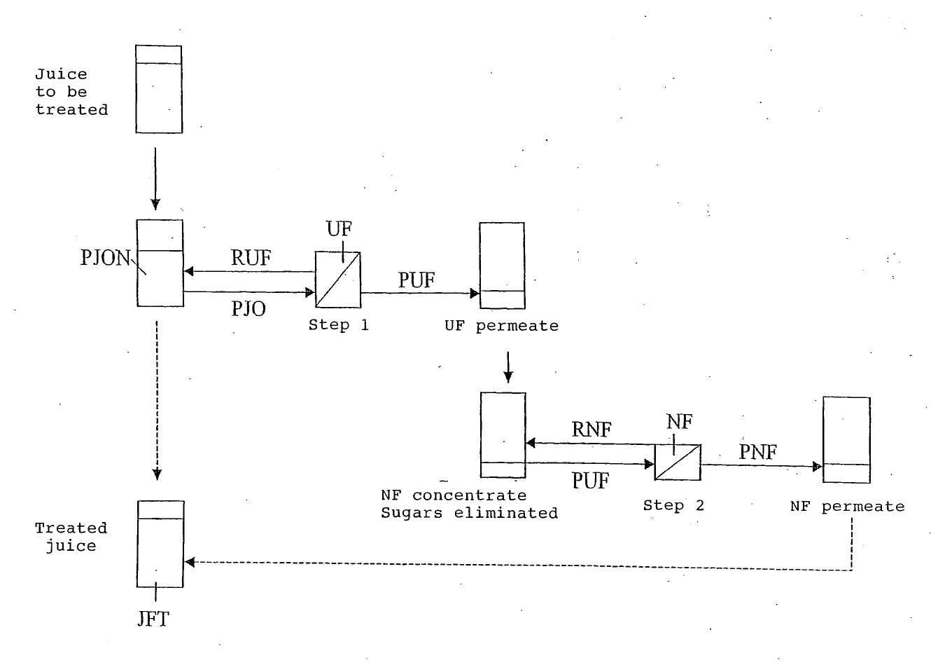

The present invention relates to the processing of comestible liquids, particularly for the at least partial modification of their composition, in particular by adjustment of the content of one of their constituents, and has for its object a process for controlled reduction of the sugar content of juice.

Thus, it is known that certain fruit juices, in particular grape juice, can contain very large quantities of sugar. This limits their possibility of consumption as fruit juice and considerably complicates their possible transformation into wine. The complete alcoholic fermentation of these high sugar juices is difficult, it requires a good oneological control and is often accompanied with undesirable microbiological deviations (large content of acetic acid).

Moreover, the wines obtained have contents of ethyl alcohol often greater than 15% by volume, which impedes their distribution. Generally, consumers, are less desirous of wines, especially red wines, containing more than 13% alcohol.

Certain wine producers, particularly in the USA, are thus obliged to partially remove alcohol from their wines to be able to sell them. The techniques used have great drawbacks. Thus, in addition to their complexity (filtration on very dense membranes+distillation), they can greatly alter the quality and taste of the wine.

It is obvious that it would be preferable to remove sugar from the grape must before fermentation, rather than removing alcohol after fermentation, but to date, there does not exist a known industrial technique permitting carrying out this operation at an acceptable cost.

It was thus desirable to use a simple technique permitting removing a predetermined quantity of sugar from a fruit juice, in general, and from grape juice in particular.

So as to satisfy this requirement, the present invention provides a process for controlled reduction of the quantity of sugar in fruit juices, in particular grape juice, characterized in that it consists in subjecting at least a portion of the original fruit juice, if desired pre-clarified, to a selective ulfra-filtration that is substantially permeable to sugars, then to a selective nano-filtration that that is substantially impermeable to sugars, and in mixing the double-filtered permeate with the retentate or concentrate of ultra-filtration and, if desired, with the portion of untreated original fruit juice, the ultra-filtration permeate being subjected to a treatment so as to eliminate or limit the phenomena of crystallization in the retentate or concentrate from nano-filtration.

The invention will be better understood from the following description, which relates to a preferred embodiment, given by way of non-limiting example, and explained with reference to the accompanying schematic drawing in which the single figure is a schematic representation of a device for practicing the process according to the invention, also showing the principal steps of this latter.

As indicated above, the process according to the invention consists principally in subjecting at least a portion PJO of original fruit juice, if desired pre-clarified, to selective ultra-filtration substantially permeable to sugars, then to a selected nano-filtration substantially impermeable to sugars, and in mixing the double-filtered permeate PNF with the retentate or concentrate of ultra-filtration RUF and if desired with the portion of untreated fruit juice PJON, the ultra-filtration permeate PUF being subjected to a treatment to eliminate or limit the phenomena of crystallization or formation of troubling material in the retentate or concentrate of nano-filtration RNF.

The mentioned treatment permits avoiding problems connected with the modification of the content of substances dissolved at their ultra-filtration and can lead to phenomena of clogging and/or closing of the nano-filtration means.

More precisely, said process can essentially comprise the steps consisting in:

removing a portion of original fruit juice PJO, if desired pre-clarified;

subjecting said portion of removed juice PJO to a selective filtration producing a retentate or concentrated RUF and a permeate PUF, the ultra-filtration used being substantially permeable to sugars and highly impermeable to other qualitative substances in the juice, in suspension and/or dissolved in this latter;

subjecting the ultra-filtration permeate PUF, after its treatment against crystallization phenomena or the formation of troublesome substances, to a selective nano-filtration generating a retentate or concentrate RNF and a permeate PNF, the nano-filtration means NF used being highly impermeable to sugars and substantially permeable to other qualitative substances in suspension and/or dissolved therein, of the ultra-filtration permeate PUF;

mixing the retentate or ultra-filtration concentrate RUF and the nano-filtration permeate PNF with a portion of un-withdrawn original juice PJON, to form a processed fruit juice JFT with a reduced sugar content.

As a practical matter and for given types of ultra-filtration means UF and nano-filtration means NF, the quantity of sugar eliminated, and hence the reduction of sugar in the fruit juice after processing, can be preferably controlled by the adjustment of the volume of ultra-filtration permeate PUF.

The treatment of the ultra-filtration permeate PUF mentioned above can for example consist in an operative step selected from the group formed by: preventive precipitation of at least one of the compounds taking place in or each phenomenon of crystallization or of formation of troublesome materials by controlled addition of at least one suitable substance in the ultra-filtration permeate PUF; the inhibition of the phenomenon or phenomena of crystallization or of formation of troublesome substances by controlled addition of at least one suitable substance in the ultra-filtration permeate PUF; limitation of the crystallization phenomenon or phenomena or of the formation of troublesome substances in question, by controlled addition of at least one stabilizing product into the ultra-filtration permeate; preventing the crystallization or forming of troublesome substances by controlled addition of at least one gelling and impoverishing product, for example by treatment by means of ion exchange resins or by electro-dialysis, of the ultra-filtration permeate PUF relative to at least one of the compounds taking place in the or each phenomenon of crystallization or the formation of troublesome substances in question.

Said at least one added product, for example by injection if desired followed by agitation, can consist in a colloidal stabilizing product, such as for example metatartric acid, a cellulose derivative, gum arabic, xanthane gum or the like or maybe a gelling product selected from the group formed by gelatin, alginate and the like.

To add value to the substances eliminated by means of the process according to the invention, it can also be provided to subject to a supplemental processing operation and/or packaging operation, the concentrate or retentate RNF from the selected nano-filtration operation.

According to a first modified embodiment of the invention, the process can be carried out continuously, at least two different operative phases being carried out simultaneously and the removal being carried out during a predetermined time.

According to a second modified embodiment of the invention, the process can be carried out sequentially, the different operative phases being carried out one after the other by being applied to a portion of the volume of original juice removed at the beginning of the operative cycle of the process.

As follows from the above discussion, the process provided by the invention utilizes two consecutive filtration steps:

first step: ultra-filtration UF of a portion of the volume of grape juice to be treated, if desired pre-clarified. There is obtained a permeate UF very less concentrated (the greater part of the colloids and the phenolic compounds is retained) whose sugar content depends on the sugar content of the grape juice and of the UF membrane used. The volume of extracted permeate should correspond to the quantity of sugar which must be eliminated (see the computation hereafter, of the volume of permeate UF).

second step: nano-filtration NF of the UF permeate obtained in the first step, after its preventive treatment against crystallization and/or the formation of troublesome compounds. There is obtained a concentrate or retentate of NF rich in sugars and a permeate of NF poor in sugar and relatively rich in acids and other qualitative constituents of the initial juice. The concentration limit NF depends on the membrane and the operative conditions. It is difficult to exceed 500 g of sugar per liter. The permeate NF is reincorporated into the vat of grape juice to be treated. The concentrated NF corresponds to the sugars eliminated from the vat.

The industrial use of the process presents no particular difficulty. The ranges of filters accepting the ultra-filtration or nano-filtration modules are known and widely used in the agro-food industry.

The efficiency of the process depends on the quality of the membranes used, which is to say their selectivity relative to the different constituents of the fruit juice treated. This selectivity is expressed by the relative quantities of rejection of each constituent.

The UF membrane should have a low rate of rejection for sugars and a high rate of rejection for the other constituents: the object is preferentially to extract sugar.

The NF membrane should have a large quantity of rejection for sugars and low rejection quantities for the other constituents: the object is preferentially to extract everything that is not sugar.

The elimination of the volumes of permeate UF and of concentrate NF can be carried out as follows:

If W is the volume of juice to be treated in liters, X the quantity of sugar to be withdrawn in g/l, and Y and Z the sugar content in g/l of respectively the permeate UF and the permeate NF, the volume V of permeate UF is about equal to:

V=X×W/(Y−Z)

Example: W=1000 l, X=25 g/l, Y=180 g/l, z=50 g/l

V=25000/130=192 l

If the sugar content of the concentrated NF at the end of treatment is equal to 500 g/l, the volume of this concentrate will be equal to: X×W/500 thus, for the example above: 25000/500=50 l.

An example of performance for fruit juice is given in the following table by way of example.

Membranes Used:

UF: spiral module reference PW of the Desal Osmonics company

NF: spiral module reference DK of the Desal Osmonics company

| | | | Total | | | Index of |
|---|---|---|---|---|---|---|
| | | | acidity | | Potas- | Total |
| | Volume | Sugars | G/l H₂ | | sium | Phenolic |
| | l | g/l | SO₄ | pH | mg/l | Compounds |
| Initial | 1000 | 250** | 4.8 | 3.84 | 1660 | 12.6 |
| juice (PJO) | | | | | | |
| Pre- | 800 | 251 | 4.85 | 3.84 | 1660 | 12.6 |
| concentrated | | | | | | |
| UF (RUF) | | | | | | |
| UP permeate | 200 | 245 | 4.7 | 3.83 | 1611 | 8.8 |
| (PUF) | | | | | | |
| NF | 92 | 500 | 5.87 | 3.92 | 2460 | 10.7 |
| concentrate* | | | | | | |
| (RNF) | | | | | | |
| NF permeate | 108 | 26 | 3.2 | 3.70 | 1081 | 1.4 |
| (PNF) | | | | | | |
| Treated | 908 | 224*** | 4.7 | 3.84 | 1538 | 13 |
| juice (JFT) | | | | | | |

*Stabilized with CMC, see below
**Corresponding alcoholic degree: 15%
***Corresponding alcoholic degree: 13.5%

Results:

the potential alcoholic degree of the must has been lowered from 15 to 13.5

Analyses of the other constituents of the must show little difference between the compositions of the must before and after treatment. The quality of the must thus does not seem to be affected by the decrease of the potential alcoholic degree.

the eliminated sugars (concentrated NF) correspond to a loss of volume of must equal to 9.2%. These sugars can be commercialized, they represent 46 kg per 1000 l of treated must.

It should be noted that the great increase in potassium content and in tartaric acid of the NF concentrate during treatment, can give rise to crystallization of the potassium bitartrate, which can impede and limit the concentration by NF, because of the risk of plugging the NF membranes.

To prevent this phenomenon of crystallization of tartaric salts, the proposed process foresees several techniques.

On could, for example, as a function of local regulations as to treatments or as to usable products:

preventatively precipitate the potassium salts by acidifying, with tartaric acid, the UF permeate and by cooling it. The separation of the crystals can take place by simple fine screening, for example with a 50 μm screen.

inhibiting the crystallization by addition of metatartaric acid or cellulosic derivatives, carboxymethylcellulose (CMC) for example, or any other product (or combination of products) having equivalent properties.

limiting the crystallization of salts by adding a colloidal stabilizing product of the type of gum arabic, xanthane gum, or any other product (or combination of products) with equivalent properties.

preventing crystallization by adding a gelling product of the type of gelatin, alginate or any other product (or combination of products) with equivalent properties.

impoverishing the UF permeate in K⁺ ions by treating it with cation exchange resins, or by electro-dialysis. These types of treatments are well known to those skilled in the art.

The stabilizing and/or gellifying products used cannot pass through the NF membrane, they are thus concentrated in the sugar syrup (NF concentrate) that is eliminated.

The present invention also has for its object, as shown schematically in the accompanying drawing figure, a device for practicing the process described above.

This device is characterized in that it comprises principally an ultra-filtration module UF substantially permeable to sugars and a nano-filtration module NF substantially impermeable to sugars, mounted in cascade, as well as means for the treatment of the ultra-filtration permeate PUF for elimination or limitation at least of the phenomena of crystallization or formation of troublesome substances in the nano-filtration retentate RNF, the ultra-filtration module UF being supplied by means of removal of juice to be treated and the ultra-filtration modules UF and nano-filtration modules NF being provided with means for pouring respectively the concentrate or ultra-filtration retentate RUF and nano-filtration permeate PNF.

Of course, the invention is not limited to the embodiment described and shown in the accompanying drawing. Modifications are possible, particularly as to the construction of the various elements or by substitution of technical equivalents, without thereby departing from the scope of protection of the invention.

1. Process for the controlled reduction of the sugar content of fruit juice, in particular grape juice, characterized in that it consists in subjecting at least a portion (PJO) of the original fruit juice, if desired pre-clarified, to selective ultra-filtration substantially permeable to sugars, then to a selective nano-filtration substantially impermeable to sugars, and in mixing the twice-filtered permeate (PNF) with the retentate or ultra-filtration concentrate (RUF) and, if desired, with a portion of the untreated original fruit juice (PJON), the ultra-filtration permeate (PUF) being subjected to a treatment to eliminate or limit the phenomena of crytallization or of formation of troublesome substances in the retentate or concentrate of nano-filtration (RNF).

2. Process according to claim 1, characterized in that it comprises essentially the steps consisting in:
removing a portion (PJO) of the original juice, if desired pre-clarified;
subjecting said portion of removed juice (PJO) to selective ultra-filtration generating a retentate or concentrate (RUF) and a permeate (PUF), the ultra-filtration used being substantially permeable to sugars and highly impermeable to other qualitative substances of the juice, in suspension and/or dissolved in this latter;
subjecting the ultra-filtration permeate (PUF), after its preventive treatment against the phenomena of crystallization or the formation of troublesome substances, to a selective nano-filtration generating a retentate or concentrate (RNF) and a permeate PNF, the nano-filtration means (NF) used being highly impermeable to sugars and substantially permeable to other qualitative substances dissolved in the ultra-filtration permeate (PUF);
mixing the retentate or ultra-filtration concentrate (RUF) and the nano-filtration permeate (PNF)-with a portion of the non-removed original juice (PJON), to form a treated fruit juice (JFT) with a reduced sugar content.

3. Process according to claim 1 or 2, characterized in that, for given types of ultra-filtration means (UF) and nano-filtration means (NF), the quantity of sugars eliminated, and hence the reduction of sugars in the fruit juice after treatment, are controlled by adjusting the volume of ultra-filtration permeate (PUF).

4. Process according to any one of claims 1 to 3, characterized in that the treatment of the ultra-filtration permeate (PUF) consists in an operative step selected from the group formed by: preventive precipitation of at least one of the components taking part in or each phenomenon of crystallization or the formation of troublesome substances, by the controlled addition of at least one suitable substance in the ultra-filtration permeate (PUF); inhibition of the phenomenon or phenomena of crystallization or formation of troublesome substances by controlled addition of at least one suitable substance in the ultra-filtration permeate (PUF); limitation of the phenomenon or phenomena of crystallization or formation of troublesome substances in question by the controlled addition of at least one stabilizing product in the ultra-filtration permeate (PUF), preventing the crystallization or crystallizations or formation of troublesome substances by controlled addition of at least one gellifying product and impoverishing, for example by treatment by means of ion exchange resins or by electro-dialysis, the ultra-filtration permeate (PUF) relative to at least one of the components taking place in the or each phenomenon of crystallization or the formation of troublesome substances in question.

5. Process according to claim 4, characterized in that said at least one added stabilizing product added to the ultra-filtration permeate (PUF) is a colloidal stabilizing product, such as for example metatartric acid, a cellulosic derivative, carboxymethylcellulose, gum arabic, xanthan gum or the like.

6. Process according to claim 4, characterized in that said at least one gellifying product added to the ultra-filtration permeate (PUF) is selected from the group formed by gelatin, alginate and the like.

7. Process according to any one of claims 1 to 6, characterized in that it consists in subjecting to a supplemental treatment operation and/or to packaging the concentrate or retentate (RNF) from the selective nano-filtration operation.

8. Process according to any one of claims 1 to 7, characterized in that it is carried out in a continuous manner, at least two of the different operative phases being carried out simultaneously and the removal being carried out during a predetermined time.

9. Process according to any one of claims 1 to 7, characterized in that it is carried out sequentially, the different operative phases being carried out one after the other by being applied to a portion of the volume of the original juice removed at the beginning of the operative cycle of the process.

10. Device for practicing the process according to any one of claims 1 to 9, characterized in that it comprises an ultra-filtration module (UF) substantially permeable to sugars and a nano-filtration module (NF) substantially impermeable to sugars, mounted in cascade, as well as means for the treatment of the ultra-filtration permeate (PUF) for the elimination or limitation of at least the phenomena of crystallization or the formation of troublesome substances in the nano-filtration retentate (RNF), the ultra-filtration module (UF) being supplied by means of removal of juice to be treated and the ultra-filtration modules (UF) and nano-filtration modules (NF) being provided with pouring means, respectively of concentrate or ultra-filtration retentate (RUF) and nano-filtration permeate (PNF).
